(19) United States
(12) Patent Application Publication
(10) Pub. No.: US 2008/0223371 A1
(43) Pub. Date: Sep. 18, 2008

(54) Nose guard mask

(76) Inventor: Samuel L. Guillory, New York, NY (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 11/724,105

(22) Filed: Mar. 14, 2007

(51) Int. Cl. A62B 7/10

(52) U.S. Cl. 128/206.18

(57) ABSTRACT

A nose guard mask made from thin polymeric film has a nostril filter element permanently bonded thereto. The remaining mask portion is coated with a skin nourishing moist cream. When the mask is applied to the nose of the user, the nostril filters line up with nose nostrils of the user. The mask portion is attached to the user's face by surface tension forces of the skin nourishing, moist cream that emits a pleasant fragrance to block unwanted odors. The mask is unobtrusive, having a relatively small size and designed color that make it barely visible. It provides nourishment to the skin of the user, and filters dust, pollen, infectious bacteria and viruses to thereby protect the wearer against infections caused by germs. A nose bridge bendable strip may be adhesively attached to the polymeric film at the bridge location to provide additional support for the mask. The ends of the bendable strip may be adhesively coated on both ends to act as a nasal dilator.

### BACKGROUND OF THE INVENTION

1. Field of the Invention

The present invention relates to ambient air filtering; and, more particularly, to a miniature, easy to wear unobtrusive nose guard device that filters dust, pollen, infectious bacteria and viruses entrained as aqueous dispersions in an expulsion of cough or sneeze, providing protection to the wearer against infections caused by germs.

2. Description of the Prior Art

Devices for protecting nasal passages as well as devices that cover the mouth are well known in the prior art. Nose protectors are either clamped to the interior central bone or cartilage region of the nose; or held by a clip against the bridge of the nose; or attached by several adhesive strips. These clamp attachment means become painful during prolonged use due to the large retaining pressure applied by the device to sensitive portions of the nose. The adhesives strips are hard to peel and cause skin irritation. When attached, the device and its retaining mechanisms create an unsightly, unattractive appearance. Several of these devices have holes or openings adjacent to the air filters used, or to device retaining fixtures, which provide ineffective air filtration and inadequate protection to the user from inhaling infectious germs.

U.S. Pat. No. 369,019 to McMaster discloses a nasal respirator. The respirator prevents inhalation of dust or poisonous chemicals that injure mucous membranes and lung surface. This celluloid device comprises a sponge or cotton material at the bottom. It is attached to the user using spring clips appointed for disposition within the nostril of the user. The pressure of the spring clips on the inside of the nose is uncomfortable. There is always a gap between the celluloid device and the nose of the user, through which unfiltered air may enter the nose. The sponge or cotton filter hangs below the nose, producing an unattractive appearance.

U.S. Pat. No. 628,111 to McHatton discloses a nose screen. The nose screen and presser applies a gentle and constant pressure and compressive force upon the gristle and bone of the nose to facilitate healing of an irritated nostril membrane due to cold, catarrh or foreign particles. The lower portion of the frame has a removable screen to exclude cold air, and particles of dust, and may contain medicinal compounds. This nose screen is removably attached to a frame, which applies gentle but constant pressure at the bone of the nose. The filtration capability of the screen is questionable. There is always a gap between the nose and the frame, allowing unfiltered air to enter the nostrils. The pressure on the bone is said to improve the healing of irritation, but this compression prevents the user from breathing through the nose, encouraging breathing through the mouth. The continuous application of pressure on the bone is quite painful.

U.S. Pat. No. 700,528 to Maurer discloses an inhaler with a nasal attachment. This nose attachment is compressed against the nostrils of the user. A spring and a friction pad in the interior of the inhaler nose attachment retain the inhaler against the nose. The medicament soaked cotton piece is only retained in place by the compression spring, which may fall down by gravity. The compression spring squeezes the nostrils, limiting the amount of air breathed through the nose.

U.S. Pat. No. 1,914,418 to Garcia discloses a nose protector. This nose protector prevents the inhalation of dust, smoke, tobacco leaf powder, etc. The nose protector is attached to the lower portion of the nose with a renewable filter. This nose protector clamps on to the nose by a yieldable body that is outwardly bulged with hinged sections. The bottom of the nose protector has a slidable insert which carries a renewable strainer clamped between two flaps, filtering dust, smoke, etc. There is no seal between the strainer and the nose. Air may therefore be respirated without passing through the filter; such air passes, instead, through the hinge of the space between the yieldable clamp and the nose.

U.S. Pat. No. 4,004,584 to Geaney discloses a facially worn breathing filter. This filter comprises fine metallic mesh placed between two coarser supporting metallic meshes and is positioned at the nostrils of the user, filtering the incoming air. The wire mesh assembly is bonded to a flexible sheet material using iron on glue and the flexible sheet is attached to the skin portion of the nostrils using a double-sided tape. The filter is solely attached to the user's nose by this adhesive tape and may cause severe skin irritation. The metallic mesh with fine mesh size has a small open area. Resistance to air flow is high, especially when moist air is breathed out. Condensed moisture in the fine spaces of the metallic mesh makes breathing more difficult. The fine mesh metallic wire assembly is not replaceable, and is subject to progressive clogging by dust.

U.S. Pat. No. 4,240,420 to Riaboy discloses a nose and mouth filter combination. This filter constitutes two separate filters attached by adhesive tape to the mouth and nose of the user. The filter comprises a pair of Kleenex™ tissue papers optionally packed with activated carbon. Use of this adhesive tape is cumbersome and may cause skin irritation. The Kleenex™ tissue paper is extremely weak, especially when moistened by breathing generated moisture. Moistened Kleenex™ tissue will separate easily from the adhesive tape especially when subjected to breath air pressure.

U.S. Pat. Nos. 4,984,302 and 5,485,836 to Lincoln disclose nose-worn air filters. Each of these devices attaches to the nose and filters the air that a person breathes through the nostrils. The filter element of each device covers the nostrils and base of the nose. Thus, the remainder of the face is uncovered. The device includes the filter element and an adhesive strip, which includes two substantially triangular portions designed to adhere to the sides of the nose and hold the filter in place. The adhesive strip is such that it securely holds the filter over the nostrils when the adhesive strip is properly placed on the sides of the nose. A triangular adhesive pad with a central filtering element is attached to the lower end of the nose. Use of adhesives produces skin irritation.

U.S. Pat. No. 5,243,708 to Vanuch discloses a disposable scented mask. This disposable, scented mask has a thickened mouthpiece portion adapting the mask to be held in position while gripped or clutched in the mouth or teeth. A chemically treated portion on the interior of the mask in the area of a wearer's nose allows a pleasant scent to combine with air permeating through the mask material on inhalation to effectively overcome unpleasant odors confronted by a wearer. This scented mask is clasped by the teeth of the user and emits a pleasant scent, combating offensive odor such as that present during changing the diaper of a baby. The teeth clinching action may activate a noise making device which distracts the baby during a diaper change. This device has no filter and does not remove dust or other nose or lung irritating particles from the air that is inhaled.

U.S. Pat. No. 5,392,773 and U.S. Published Patent Application No. 2004/0194784 to Bertrand discloses a respiratory particulate filter. This respiratory particulate filter removably adheres to the lower surfaces of the user's nose causing a fine mesh filtering material to cover the nostrils. A fine particle mesh filter fabric is attached to a specially shaped triangular flexible synthetic material adhesive. The adhesive is attached to the lower portion of the nose. This adhesive attachment to the lower end of the nose may irritate skin. The filter used is not replaceable.

U.S. Pat. No. 5,636,629 to Patterson discloses a nasal glove. This nose filter device is a unitary item, which fits snugly on the nose. This unitary nasal glove has two parts. The first part is a filter material and the second part is a flexible perimeter. The filter material is glued or stitched to the flexible support. The nasal glove is wrapped around the nasal passages of the user and the flexible perimeter is shaped to conform to the shape of the nose of the user, thereby retaining the nasal glove attached to the nose without use of any adhesive. There is clearly no seal between the flexible perimeter of the nasal glove and the nose and therefore unfiltered air may enter the nose and is inhaled by the user. Since the shape of the nose is tapered, slight vertical displacement of the nasal glove, will result in loss of a snug fit of the nasal glove increasing the possibility of inhaling unfiltered air.

U.S. Pat. No. 5,718,224 to Muchin discloses a transparent nasal dilator. This transparent nasal dilator has a polymeric spring member attached to an adhesive pad member. The user attaches the spring member to the bridge of the nose and secures the adhesive pad, thereby dilating nostrils for improved breathability. There are no filtration devices for removing dust, etc. from the inhaled air. Use of adhesive attachment to the nose irritates the skin.

U.S. Pat. No. 5,740,798 to McKinney discloses disposable nasal band filter. This is a nasal band with a central filter portion that is attached to two transparent adhesive strips. The central filter portion is stitched to the adhesive end portions using an elastic thread. The adhesive portions are attached to the face adjacent to the nose while the central portion loosely covers the nostrils. Due to the elastic thread, the filter portion may be adjusted to fit the nose of the user. There is no seal between the nose and the filter element other than at the two edges that contact the adhesive strips. The use of adhesive strips may irritate skin.

U.S. Pat. No. 6,098,624 to Utamaru discloses simple mask for protection of respiratory system. This simple, inexpensive mask comprises a triangular filter portion with two holes for the two nostrils held in place by two adhesive strap members with a plurality of perspiration evaporating holes. Also provided is a flap, which may be adjusted to a distance between the nose and the lip to secure the filter. Since the simple mask is retained by adhesive straps with holes and a flap with no holes, skin irritation is expected in the skin contacting areas.

U.S. Pat. No. 6,116,236 to Wyss discloses a respirator. This respirator covers both the nose and mouth of the user, not just the nose of the user. It is held in place by two elastic bands. A seal is optionally provided at the edge of the respirator cup. A metallic clamp with an adhesive is provided at the nose bridge to function as a nasal dilator. The respirator device is unattractive, having two elastic bands covering over half of the face.

U.S. Pat. No. 6,341,606 to Bordewick et al. discloses a disposable respiratory mask with an adhesive skin interface. A bag is adhesively attached to the face of the user and provided with an air supply through an interface tube. The respiratory mask has no filters and relies on air or gas supply. The vent holes are said to exhaust carbon dioxide. However, the pressure of the supplied air or gas is clearly greater than that generated by the breath exhalation and the vents will be open at all times exhausting incoming air or gas from the supply source. The vents therefore cannot preferentially exhaust carbon dioxide.

U.S. Pat. No. 6,752,149 to Gillespie et al. discloses a nasal mask with a replaceable filter. This device is a breathing filter with a nose mask with strap(s) and a filter member. The nose filter is made from a unitary body with a plug in replaceable filter that is held in place by elastic bands. Sealing of the filter against the skin of the user is provided by a foam cushion, and the mast is held in place by a pair of elastic straps. The presence of straps makes the device unattractive. Since the filter is a plugged in device, the pressure exerted by the inhaled air during the breath out cycle may dislodge the filter plug. The plug is supported in one direction only, i.e. during the breathing in cycle of the inhalation process.

U.S. Pat. No. 6,971,388 to Michaels discloses an internal nasal dilator filter. A foam filter inserted into each of the nostrils of the user and connected by a strong elastic band that is bent into a U shape applies pressure on the nostrils to dilate the air passages of the nose. This device filters at the same time as it dilates the nasal passages of the user. The device is not attached over the nose, but rather is inserted into the nasal passages. The pressure applied inside the nose may damage delicate blood vessels in the nose, since the pressure is present at all times. Moreover, the dilatation is required at the bridge of the nose, not at the bottom end of the nose—a key feature provided by the invention.

U.S. Pat. No. 7,004,165 to Salcido discloses a nose filter. This filtering apparatus fits adjacent to the nostrils and nose of the user and includes a rigid base for retaining a filtering material thereon through which the user may breathe. Open celled foam is held against the nose of the user by two hinged support frames, which rest on the ears of the user. The frame is attached to support plates with a plurality of holes that squish the open celled foam against the nostrils of the user. The presence of the ear supports and a squished open cell foam makes this filtration device unattractive.

U.S. Published Patent Application No. 2004/0089303 to Chien discloses a nose filter device. The nose filter device has a holder, which attaches to one large filter or multiple smaller filters and is adhered to the lower nose portion of the user so that the filter covers the nostrils. Use of an adhesive in this manner may irritate the skin.

U.S. Published Patent Application No. 2006/0150980 to Kim discloses an anion emission and anti-dust nose mask. A filter made from nano fiber is attached to a frame that may be bent at a hinge to secure the filter over the nose. To prevent the displacement of the filter, a settling unit that carries a magnet is inserted into the nostril cavities. The magnet attracts the bent steel frame holding the device in place without the use of spring supports or adhesives. Since nose member of the user is highly flexible, the pressure applied by the bent frame is small and incapable of retaining the frame against the nostrils. The magnet is attached to the setting unit inserted through the nose and its support is also expected to be small. Therefore the attachment of the nose mask to the nose is at best weak.

U.S. Published Patent Application No. 2006/0016450 to Pearson et al. discloses an air filter device for the nose. Two filters are inserted into annular portions in a malleable support frame, which is supported on the nose of the user. The filters are inserted into the nostrils of the user and filters at the inhaled air. The presence of the malleable nose bridge is unsightly and its support and locating ability to retain the filters within the nostrils is questionable, due to the general taper of the nose bridge.

Foreign Patent Application No. JP2000-167074 to Kouho discloses a nose mask worn via pressure sensitive adhesive double coated tape. This is a sponge with adhesive tape that is adhered to the lower end of the nose. The adhesive attachment using double sided tape will irritate skin.

Foreign Patent Application No. JP2000-342704 to Wai discloses air filter for nose. The hollow body of the nose filter is made from a filtering material and is attached to the nose of the user by adhesive tape. Use of this method of attachment irritates skin. The hollow body of filtering material has porosity and its bond to the adhesive material is weak, at best.

Foreign Patent Application No. JP2001-145703 to Shimada discloses a nose mask. The mask is made from non-woven fabric. It covers the nose, not the mouth and is attached using air permeable adhesive tape. The use of adhesive tape for attachment irritates the skin.

Foreign Patent Application No. JP2003-305135 to Akeura discloses a bandage type nose mask. This bandage type filter film is adhered to the lower end of the nose. Use of this adhesive method of bonding irritates skin.

Foreign Patent Application No. JP09-294819 to Saki discloses a nose mask. The main body of the nose mask has two vent holes in the bottom, which are close to the nostrils carrying a filter. The nose mask is supported on the eye cup of the user. This method of attachment of the nose mask is ineffective since the mask may easily fall off.

Foreign Patent Application No. JP11-137701 to Sato discloses a nose mask. The mask comprises a molding with a laminate of base material and filter material. Since the base layer is the same shape and size as the filter layer, the non-porous base layer prevents inhalation of air. The molding also has an adhesive layer, which is also not expected to allow inhalation of air. The use of adhesive irritates skin.

Notwithstanding the efforts of prior art workers to construct a filter device attached to the nose preventing entry of dust, pollen and infectious germs, there is clearly a need for an unobtrusive attractive filter that is securely held against the nose without use of painful clips or other skin irritating adhesive attachments that surround the filter.

### SUMMARY OF THE INVENTION

The present invention provides a mask that is relatively small and not obtrusive in appearance—in essence a “mini-mask” sized to fit over a wearer's nose. The mask functions to mitigate and protect the wearer against catching a cold, which might otherwise be transferred from a person nearby that is coughing and sneezing.

The nose guard mask comprises: (i) a nose mask portion adapted to be worn on a person's nose, the nose mask portion having a nostril section, a mid section, a bridge section and a nose surrounding section; (ii) the nostril section of the nose mask portion further comprising nostril filters adapted to be in close proximity and to engage with a person's nostrils; (iii) the bridge section of the nose mask portion further comprising a bridge support piece adapted to be in close proximity and to engage with a bridge of the person's nose; and (iv) the nose mask portion being made from a pliable thin polymeric film material that is coated with skin compatible moist cream that sticks to the skin, providing an airtight containment while, at the same time, nourishing the skin The nose surrounding section may extend beyond the nose, covering the face in the range of 0.5 cm to 2 cm. An alternative feature of the nose guard mask includes additionally an adhesively attached bendable strip on the skin contacting surface of the polymeric film in close proximity with the bridge support piece or bridge section of the mask portion. In an alternate second embodiment, the bendable strip may additionally include adhesive end sections and an adhesive on either side to act as a nasal dilator. In addition, the bridge support piece may further comprise bridge guards.

The cream used is a commonly available skin soothing cream. This cream typically contains ingredients, including one or more humectants such as glycerin, urea, lactic acid and or sorbitol, one or more natural moisturizing factors of low molecular weight substances such as ammonia, aminoacids, glucosamine, creatine, citrate and chloride, phosphate solutions of sodium, potassium, calcium or magnesium, one or more emollients such as lanolin, oil water emulsions, esters such as octyl dodecanol, hexyl decanol, oleyl alcohol, decyl oleate, isopropyl stearate, isopropyl palmitate, isopropyl myristate, hexyl laureate, and dioctyl cyclohexane. The cream also typically contains emulsifiers, preservatives, fragrance enhancers such as menthol, mint and the like, that ameliorate unpleasant odors and, optionally, vitamins A, B, C, D and E. The cream wets the polymeric shell of the nose guard mask. When the nose guard is applied to the face of the user, the cream immediately creates a seal between the face and the polymeric film, while nourishing the skin of the user. The cream essentially holds the nose guard mask against the nose of the user and is not easily dislodged. Surface tension of the cream stabilizes the nose guard mask, preventing dislodgement even when the user jumps or otherwise moves vigorously.

### BRIEF DESCRIPTION OF THE DRAWING

The invention will be more fully understood and further advantages will become apparent when reference is had to the following detailed description of the preferred embodiments of the invention and the accompanying drawings, in which:

FIG. 1 is a schematic diagram of a person fitted with nose guard mask secured over the nose;

FIG. 2 is a side view of nose guard mask when worn on a person's nose;

FIG. 3a depicts an alternate embodiment of the nose guard mask is additionally fitted with a bendable metallic or plastic strip for nose bridge support of the mask; and

FIG. 3b Illustrates the details of the bendable metallic or plastic strip.

### DETAILED DESCRIPTION OF THE INVENTION

This invention relates to a nose guard mask that is easily attached to the nose of the user effectively filtering dust, pollen and bacteria, without any discomfort to the skin of the user. The nose guard mask comprises a nose mask made from a polymeric film that is coated with moist cream on its skin-contacting surface. The nose mask has a nostril section, a mid section, a bridge section and a nose surrounding portion. The nostril section is provided with a filter at the nostril area and is composed of a woven, non-woven or particulate filter. Such a filter has spacing between fibers thereof in the range of 0.1 to 0.5 microns, and preferably from 0.15 to 0.3 microns, thereby enabling filtration of fine dust and microbial agents. This filter may be permanently bonded to the nose mask by stitching, thermoplastic hot glue bonding or a thermoset polymer bond. The nostril area has an extension region, which contacts the area between the nose and the upper lip, to thereby provide an air seal. The surface tension forces of the moist cream coating on the skin contacting surfaces of the nose mask is generally adequate to hold the mask in place. The nose surrounding section of the mask portion generally extends 0.5 cm to 2 cm beyond the nose, adhesively held in place by the skin nourishing moist cream. In an alternate embodiment, a second support in the form of a bridge support besides the support provided by the surface tension of the moist cream is additionally provided at the bridge section of the nose guard mask. This bridge support is a bendable metallic or plastic piece that is attached to the interior skin-contacting surface of the nose mask at the bridge section. The bendable metallic or plastic strip may have an adhesive coating adapted to effect a permanently bond with the polymeric film. The bendable metallic or plastic bridge support may be provided with bridge guards to prevent injury to skin. In a second alternate embodiment, this bendable metallic or plastic piece may be a Breathright Strip™, which has additionally an adhesive layer at the skin-contacting surface that dilates the nostrils at the bridge portion of the nose, improving inhaled air flow.

Generally stated, the germ filtering nose guard mask is appointed to be worn in public environments to avoid transfer of airborne germs. The germ filtering nose guard mask broadly comprises: (i) a nose mask portion adapted to be worn on a person's nose, the nose mask portion having a nostril section, a mid section, a bridge section and a nose surrounding portion; (ii) the nostril section of the nose mask portion further comprising nostril filters adapted to be in close proximity and to engage with nostrils of the person's nose; (iii) the bridge section of the nose mask portion further comprising a bridge support piece adapted to be in close proximity and to engage with a bridge of the person's nose, and (iv) the nose mask portion being made from a thin collapsible polymeric material coating with moist skin cream that intimately adheres to the nose skin providing a skin nourishing airtight seal for the germ filtering nose guard mask.

In today's highly mobile society, travelers in public places are often concerned with encountering airborne germs. Of particular concern are areas, which place many people from different regions in close proximity to one another. These include airports, bus terminals, and train stations, all of which pose risks that travelers will catch communicable diseases. The germ filtering nose guard mask is especially suited to mitigate the spread of airborne diseases by providing a guard for a person's nose. By covering the nostrils of the nose and providing filtration for breathing, the germ filtering nose guard mask mitigates or prevents the user from inhaling infectious germs. The germ filtering nose guard mask readily fits onto the wearer's nose, and is relatively inconspicuous when worn. A bridge support piece integrally constructed within a nose mask portion of the germ filtering nose guard mask rests upon the wearer's nose-bridge. At the same time, the nostrils of the wearer are covered by filters integrally constructed within a nostril section of the nose-mask portion. Advantageously, the germ filtering nose guard mask is conveniently placed on the nose of a person so that the mask covers the nostrils and body of the nose in a discrete, comfortable manner. The germ filtering nose guard mask is relatively small and not obtrusive in appearance. Yet, it functions to mitigate and protect the wearer against catching a cold, which might otherwise be transferred from a person nearby that is coughing and sneezing.

The germ filtering nose guard mask provides a protection device that is easy to apply, protecting the user from inhaled dust, pollen and other air contaminants. Moreover, the germ filtering nose guard mask protects the user from bacteria and other germs. Viruses having typically nanometer size dimensions cannot be filtered by filters of this type. However, water droplets such as are produced by a cough or sneeze entraining the viruses and infectious germs are completely stopped by the filter, preventing entry of viruses contained therein. The germ filtering nose guard mask is attached to the nose by surface tension forces of the moist skin cream, which nourishes the skin, and by a bendable metallic or plastic bridge support.

The sin moisturizing cream used may include a simplest, but effective composition such as a stearate, olive oil, water and glycerin, or a commonly used commercial skin soothing cream. These soothing creams include a) a humectants such as glycerin, urea, lactic acid and or sorbitol, b) a natural moisturizing factors of low molecular weight substances such as ammonia, aminoacids, glucosamine, creatine, citrate and chloride, phosphate solutions of sodium, potassium, calcium or magnesium, c) an emollient such as lanolin, oil water emulsions, esters such as such as octyl dodecanol, hexyl decanol, oleyl alcohol, decyl oleate, isopropyl stearate, isopropyl palmitate, isopropyl myristate, hexyl laureate, and dioctyl cyclohexane, d) emulsifiers, preservatives, fragrance enhancers such as menthol, mint and the like that ameliorate unpleasant odors, medicaments, relaxants and optionally vitamins A, B, C, D and E. The cream wets the polymeric shell of the germ filtering nose guard mask. When the germ filtering nose guard is applied to the face of the user, the cream immediately creates a seal between the face and the polymeric film, while the soothing cream nourishes the skin of the user. The cream essentially holds the germ filtering nose guard mask against the nose of the user and is not easily dislodged. Surface tension of the cream operates to stabilize the mask, preventing dislodgement even when the user jumps or otherwise moves around vigorously.

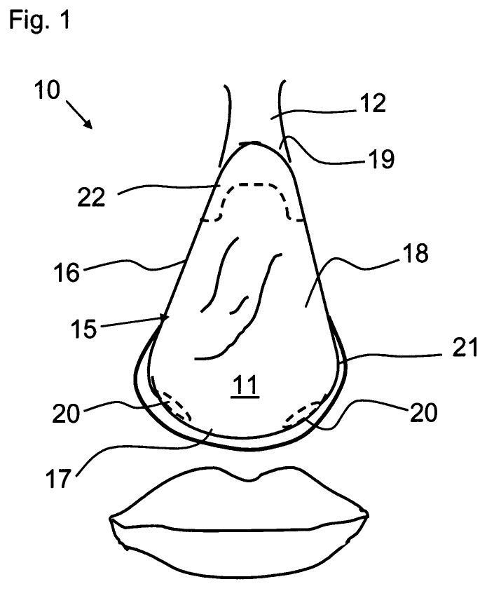

FIG. 1 illustrates generally at 10 a schematic view of the germ filtering nose guard mask, as worn on a person's nose. The germ filtering nose guard mask 15 is worn on the nose 11 of a person. Nose 11 includes the nose body having nostrils therein, and the nose bridge 12. The germ filtering nose guard mask 15 comprises a nose mask portion 16 with a moist cream on the contacting surfaces appointed to be worn on a person's nose. Nose mask portion 16 includes a nostril section 17, mid section 18, and bridge section 19. The nostril section 17 of nose mask portion 16 further comprises nostril filters 20 adapted to be placed in close proximity and into engagement with nostrils of the wearer. Nose mask portion 16 has extension piece 21, which contacts the portion between the nostrils and the upper lip. Nostril filters 20 include filters appointed to filter-out and prevent the passage of airborne germs into the nasal passageway. At the same time, the filters promote breath-ability, enabling the wearer to breathe more easily. The surface tension of the moist cream on the skin contacting surfaces of the mask 16 firmly attaches the mask to the skin of the user creating an airtight seal while operating concurrently to nourish the wearer's skin. Bridge section 19 of nose mask portion 16 further comprises a bridge support piece 22 adapted to be placed in close proximity and to engage with bridge 12 of the wearer's nose 11.

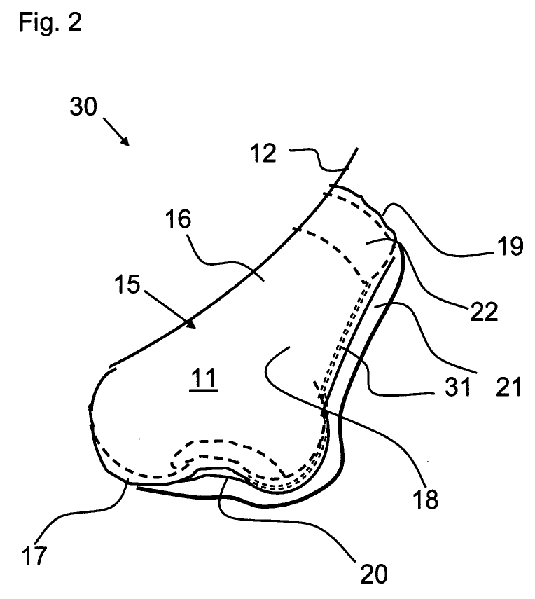

FIG. 2 illustrates generally at 30 a side view of the germ filtering nose guard mask as worn on a person's nose. The germ filtering nose guard mask 15 is worn on nose 11 having nostrils and nose bridge 12. Nose mask portion 16 includes nostril section 17, mid section 18, and bridge section 19. Nostril section 17 of nose mask portion 16 further comprises nostril filters 20 appointed to be in close proximity and engage with a person's nostrils. Nose mask portion 16 comprises extension piece 21, which contacts the portion between the nostril and the upper lip. Bridge section 19 of nose mask portion 16 further comprises a bridge support piece 22, which is a bendable metallic or plastic piece that is affixed to the interior of the nose mask portion 16. Optionally, the skin-contacting surface of the bendable metallic or plastic bridge support attaches the germ filtering nose guard mask to the nose of the user. The adhesives may be placed so that the bendable metallic or plastic bridge support contacts the nose on the sides so as to dilate nasal passages improving flow of inhaled air.

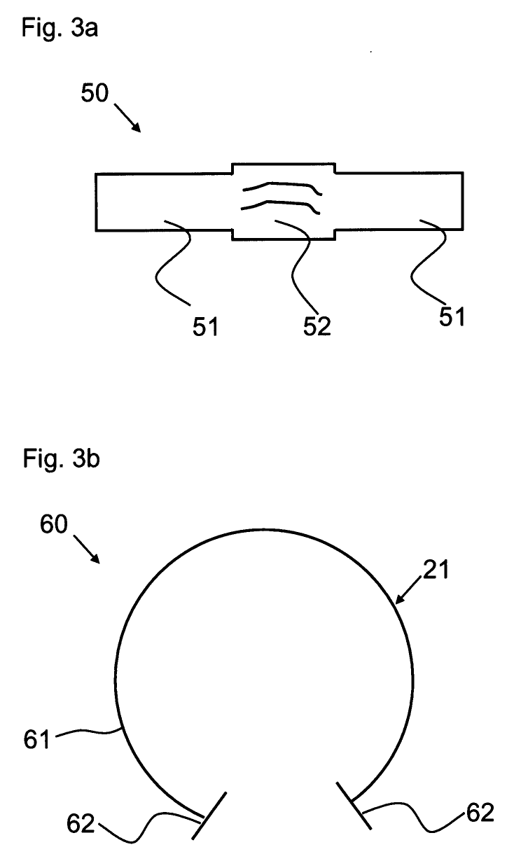

FIGS. 3a and 3b illustrate alternative features of the germ filtering nose guard mask, including: FIG. 3a illustrates generally at 50 a bendable metallic or plastic strip which may be incorporated into the germ filtering nose guard mask 15. FIG. 3b illustrates generally at 60 an embodiment of the bridge support piece 22. Referring to FIG. 3a, the germ filtering nose guard mask 15 may include a strip 50 disposed in close proximity with the bridge support piece 22 or bridge section 19 of the skin contacting surface of the nose mask portion 16. The strip may include adhesive end sections 51 and an adhesive center 52. The strip 50 may be adapted to allow vapors to escape from end sections 51, and or center 52. Strip 50 may be a BreathRite™ strip attached in the interior of the nose mask portion 18 to facilitate easier breathing. The germ filtering nose guard mask 15 is especially suited to work with a BreathRite™ strip or the like. However, the germ filtering nose guard mask 15 can be used independently thereof. Referring to FIG. 3b, the bridge support piece 22 may comprise a nose collar portion 61 appointed to rest upon and substantially receive bridge 12 and the lateral thereof of nose 11. Bridge support piece 22 may further comprise bridge guards 62 appointed to substantially grasp the sides of bridge 12 of nose 11 to facilitate secure attachment of the germ filtering nose guard mask to the wearer.

The key components of the nose guard mask comprise, in combination, the features set forth below:
1. a mask portion composed of thin polymeric film;
2. the mask portion having a nostril section, mid section, bridge section and nose surrounding section;
3. said mid section, bridge section, and nose surrounding section being coated on the skin contacting side with moist skin cream having sufficient surface tension characteristics facilitating instant adherence to skin on the nose, providing an airtight seal while concurrently nourishing the skin and preventing skin irritation;
4. said nostril section having a permanently bonded filter area designed to be located at the nostrils, while the surrounding moist cream coated surfaces contact the skin of the nose and skin between the upper lip and the nose;
5. said filter being composed of woven, non-woven, electro-statically charged fibers having a inter fiber spacing in the 0.3 micron range to filter out germs, dust, pollen and other airborne contaminants; and
6. in an alternate embodiment, the nose guard mask additionally having a mask nose bridge section of a bendable strip, preferably a bendable metallic or plastic strip, adhesively attached to the polymeric film at the bridge portion;
7. in a second alternate arrangement, the end sections of the bendable strip is adhesive coated in the skin contacting portion to contact skin and dilate nasal passages in a manner similar to commercially available Breathright™ strip;
whereby the seal generated by moist cream on the skin-contacting surface of the nose guard mask combined with the bendable metallic or plastic strip optionally including an adhesive, provides reliable attachment of the nose guard mask to the nostrils of the user, causing inhaled air to pass through the filtration elements and thereby protect the user from dust, pollen, germs and the like.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A nose guard mask, comprising:
a. a mask portion composed of a thin polymeric film having a size sufficient to cover the nose and extend along the face in areas surrounding the nose portion;
b. said mask portion having a nostril section, a mid section, a bridge section and a nose surrounding section;
c. said mid section, bridge section and nose surrounding section being coated on the skin-contacting side with an adhesive providing, skin nourishing moist skin cream facilitating instant adherence to skin on the nose, providing a substantially airtight seal; and
d. said nostril section having a permanently bonded filter area designed to be located at the nostrils of the user while the surrounding moist cream coated surfaces contact the skin of the nose as well as skin between the upper lip and the nose;
whereby the seal generated by moist cream on the skin-contacting surface of the nose guard mask provides for reliable attachment of the nose guard mask to the nostrils of the user, causing inhaled air to pass through the filtration elements and thereby protect the user from dust, pollen and infectious germs.

2. A nose guard mask as recited by claim 1, wherein said filter is permanently bonded to said nostril section by stitching, thermoplastic hot glue bonding or thermoset glue bonding.

3. A nose guard mask as recited by claim 1, wherein said filter is composed of woven, non-woven, electro-statically charged fibers having a inter fiber spacing in the range of 0.1 to 0.5 micron to filter out germs, dust, pollen and other airborne contaminants.

4. A nose guard mask as recited by claim 3, wherein said filter contains a particulate filter element.

5. A nose guard mask as recited by claim 1, wherein said nose surrounding section of the mask portion polymeric film extends for 0.5 cm to 2 cm surrounding the nose area.

6. A nose guard mask as recited by claim 1, wherein said moist cream is a mixture of stearate, olive oil and glycerin

7. A nose guard mask as recited by claim 1, wherein said skin nourishing moist cream contains one or more humectants, one or more natural moisturizing factors of low molecular weight substances and one or emollients.

8. A nose guard mask as recited by claim 7, wherein said humectants are selected from glycerin, urea, lactic acid or sorbitol.

9. A nose guard mask as recited by claim 7, wherein said natural moisturizing factors of low molecular weight substances are selected from ammonia, aminoacids, glucosamine, creatine, citrate and chloride, phosphate solutions of sodium, potassium, calcium or magnesium.

10. A nose guard mask as recited by claim 7, wherein said emollients are selected from lanolin, oil water emulsions, esters including octyl dodecanol, hexyl decanol, oleyl alcohol, decyl oleate, isopropyl stearate, isopropyl palmitate, isopropyl myristate, hexyl laureate, and dioctyl cyclohexane.

11. A nose guard mask as recited by claim 7, wherein said skin nourishing moist cream further contains emulsifiers, preservatives, fragrance enhancers, such as menthol, mint and the like that ameliorate unpleasant odors, and vitamins.

12. A nose guard mask as recited by claim 1, wherein said filter is composed of woven, non-woven, electro-statically charged fibers having a inter fiber spacing in the range of 0.15 to 0.3 micron to filter out germs, dust, pollen and other airborne contaminants.

13. A nose guard mask, comprising:
a. a mask portion composed of a thin polymeric film having a size sufficient to cover the nose and extend along the face in areas surrounding the nose portion;
b. said mask portion having a nostril section, a mid section, a bridge section and a nose surrounding section;
c. the bridge portion having a bendable strip that is adhesively bonded to said polymeric film at the nose bridge contacting portion;
d. said mid section, bridge section and nose surrounding section being coated on the skin-contacting side with skin nourishing moist skin cream facilitating instant adherence to skin on the nose, providing an airtight seal; and
e. said nostril section having a permanently bonded filter area designed to be located at the nostrils of the user while the surrounding moist cream coated surfaces contact the skin of the nose and skin between the upper lip and the nose;
whereby the seal generated by moist cream on the skin-contacting surface of the nose guard mask, combined with said bendable strip at the nose bridge, provides for reliable attachment of the nose guard mask to the nostrils of the user, causing inhaled air to pass through the filtration elements and thereby protect the user from dust, pollen and infectious germs.

14. A nose guard mask as recited by claim 13, wherein said bendable strip is a metallic or plastic bendable strip.

15. A nose guard mask as recited by claim 14 wherein said bendable metallic or plastic strip is coated with adhesive on the skin contacting surface of the nose bridge to dilate nasal passages and provide improved breathing.

16. A nose guard mask as recited by claim 13, wherein said filter is composed of woven, non-woven, electro-statically charged fibers having a inter fiber spacing in the range of 0.1 to 0.5 micron to filter out germs, dust, pollen and other airborne contaminants.

17. A nose guard mask as recited by claim 1, wherein said filter is composed of woven, non-woven, electro-statically charged fibers having a inter fiber spacing in the range of 0.15 to 0.3 micron to filter out germs, dust, pollen and other airborne contaminants.
